(19) United States
(12) Patent Application Publication
(10) Pub. No.: US 2025/0084907 A1
(43) Pub. Date: Mar. 13, 2025

(54) WEAR PAD IN A SPRING SUSPENSION SYSTEM AND METHOD THEREOF

(71) Applicant: MAC TRAILER MANUFACTURING, INC., Alliance, OH (US)

(72) Inventor: Scott A. Kibler, Kensington, OH (US)

(73) Assignee: MAC TRAILER MANUFACTURING, INC., Alliance, OH (US)

(21) Appl. No.: 18/884,933

(22) Filed: Sep. 13, 2024

Related U.S. Application Data
(60) Provisional application No. 63/582,333, filed on Sep. 13, 2023.

(51) Int. Cl. F16F 1/20; B60G 11/10

(52) U.S. Cl. CPC F16F 1/20; B60G 11/10; B60G 2202/112; B60G 2206/428

(57) ABSTRACT

A wear pad having a sacrificial surface is disposed between a leaf spring in a leaf spring suspension system of a vehicle and a portion of a mounting bracket coupled to the leaf spring. The sacrificial surface is configured to contact the leaf spring and wear down in response to movement of the leaf spring. The sacrificial surface is configured to protect at least one of the portion of the mounting bracket and the leaf spring from frictional wear-and-tear.

### CROSS REFERENCE TO RELATED APPLICATIONS

This application claims the benefit of U.S. Provisional Application Ser. No. 63/582,333, filed on Sep. 13, 2023; the disclosure of which is incorporated herein by reference.

### TECHNICAL FIELD

This disclosure is directed to components for a suspension system.

### BACKGROUND ART

A leaf spring is a suspension system component commonly used in vehicles, particularly in trucks, vans, and trailers. The leaf is designed to absorb and distribute the forces generated by the movement of the vehicle, providing a smoother ride and helping to maintain proper contact between the tires and the road surface.

A leaf spring comprises several thin, curved metal strips (known as leaves or singularly, a leaf) of varying lengths stacked on top of each other and held together by clamps or fasteners at both ends. The longest leaf, called the main leaf, is attached to the vehicle's chassis or frame, while the shorter leaves are progressively stacked on top of it, decreasing in length.

When the vehicle encounters bumps, potholes, or uneven road surfaces, the leaf spring flexes and absorbs the shock, distributing the force across the entire length of the spring. This helps to dampen the impact and minimize the transfer of vibrations to the vehicle's body and occupants. Leaf springs are relatively simple and robust components, making them suitable for heavy-duty applications, such as trucks, trailers and other commercial vehicles.

A leaf spring connects to a vehicle through a combination of mounting points on both the chassis (frame) of the vehicle and the axle or suspension component. The main leaf of the leaf spring is the longest and typically has mounting holes or brackets at its ends. These brackets are bolted or otherwise secured to the chassis of the vehicle. The main leaf is mounted in a way that allows it to pivot as the suspension flexes. In the stack of shorter leaves that sit on top of the main leaf, there's a central bolt that goes through holes in the leaves. This bolt serves as a pivot point, allowing the leaves to flex and move as the suspension reacts to road conditions. The other end of the leaf spring is connected to the vehicle's axle or suspension component. This connection is usually made using a U-bolt or a similar clamp-like mechanism. The U-bolt wraps around the axle and secures the leaf spring in place, maintaining the connection while still allowing for movement. To accommodate the flexing and movement of the leaf spring, a shackle is often used at one end of the main leaf. The shackle is a hinged bracket that attaches to the chassis and allows the leaf spring to pivot while still maintaining a secure connection. As the suspension moves, the shackle allows the distance between the chassis and the axle to change, which helps absorb shocks and vibrations.

The combination of the main leaf, shorter leaves, center bolt, U-bolt or clamps, and the shackle work together to provide the leaf spring suspension system's flexibility and load-carrying capabilities. When the vehicle encounters bumps or uneven surfaces, the leaf spring flexes at its pivot points, absorbing and distributing the forces to provide a smoother ride and protect the vehicle's chassis and occupants from excessive jolts.

The shackle is held in place by its connection to both the chassis of the vehicle and the leaf spring. The shackle is a hinged bracket that allows for movement of the leaf spring while maintaining a secure attachment to the chassis. One end of the shackle is attached to the chassis of the vehicle using a mounting bracket. This bracket is typically bolted to the frame of the vehicle. The shackle's bracket has a pivot point that allows the shackle to pivot as the suspension moves. The pivot point is often a bushing or a bearing that enables the shackle to move smoothly. The other end of the shackle is attached to the main leaf of the leaf spring. The shackle's bracket has a hole or a pin that goes through a hole in the main leaf. This attachment allows the leaf spring to move up and down as the suspension reacts to bumps and road conditions.

The combination of the shackle's pivot point on the chassis and its attachment to the leaf spring allows the leaf spring suspension to flex and articulate properly. As the suspension moves, the shackle allows the distance between the chassis and the axle to change, accommodating the vertical movement of the suspension while maintaining a secure connection.

Some leaf spring suspension system components do not require the use of a shackle and instead use a curved end of the leaf that is retained by a bar or rod. The curved end has a tip that is restricted from moving too far in a direction that would cause it to be disconnected form the mounting bracket.

The mounting bracket used as the chassis attachment for the shackle can show signs of wear and tear over time due to the movement and forces experienced by the leaf spring suspension system. As the suspension moves and the shackle pivots, the mounting bracket undergoes repeated stresses and vibrations, which can lead to several types of wear and potential issues.

The movement of the shackle against the mounting bracket can cause friction and abrasion. Over time, this can wear down the surfaces of both the bracket and the shackle, potentially leading to grooves or indentations. Abrasion and friction play a significant role in the wear and tear of suspension components like the shackle and mounting bracket. As the vehicle encounters uneven road surfaces, the leaf spring suspension system reacts by allowing the shackle to pivot on its mounting point. This movement generates contact between the shackle and the mounting bracket. The mechanical forces at play create friction as these components slide against each other. This friction generates heat and pressure at the contact points, leading to gradual material removal through abrasive action.

The consequences of friction and abrasion may not be immediately noticeable, but over time, even small amounts of material removal can add up. The repeated cycles of movement and contact cause microscopic particles to be worn away from the surfaces of the shackle and the mounting bracket. As the material wears down, it can lead to the formation of grooves, indentations, and surface irregularities. These changes in surface topography create conditions for further localized friction, which accelerates the wear process. Ultimately, these small-scale damages can compromise the structural integrity of the components, potentially leading to premature failure.

The wear and grooving caused by friction and abrasion have a direct impact on the longevity of the shackle and the mounting bracket. Over time, the material loss can weaken the affected areas, making them more susceptible to stress concentrations and fatigue. The grooves and indentations can act as stress concentrators, where forces are concentrated on specific points. This concentration of stress can lead to cracks or fractures developing from these weakened areas. As the wear progresses, the mechanical properties of the shackle and bracket can deteriorate, leading to reduced load-carrying capacity and overall suspension performance.

### SUMMARY OF THE INVENTION

Issues, such as those caused by friction and abrasion, continue to exist in a suspension system. In one particular embodiment, the present disclosure addresses the issues caused by friction and abrasion in a leaf spring suspension system by providing a wear pad for a leaf spring suspension system.

In one aspect, an exemplary embodiment of the present disclosure may provide a wear pad having a sacrificial surface is disposed between a leaf spring in a leaf spring suspension system of a vehicle and a portion of a mounting bracket coupled to the leaf spring, wherein the sacrificial surface is configured to contact the leaf spring and wear down in response to movement of the leaf spring, and the sacrificial surface is configured to protect at least one of the portion of the mounting bracket and the leaf spring from frictional wear-and-tear. This exemplary embodiment or another exemplary embodiment may further comprise a configuration that is shaped complementary to one of the portion of the mounting bracket and the leaf spring. This exemplary embodiment or another exemplary embodiment may further provide that the configuration is a U-shaped configuration. This exemplary embodiment or another exemplary embodiment may further comprise a feature to promote removal of the wear pad after the sacrificial surface is worn down and subsequent installation of a second wear pad. This exemplary embodiment or another exemplary embodiment may provide that the feature to promote the removal of the wear pad is a releasable connector. This exemplary embodiment or another exemplary embodiment may further comprise a first leg; a second leg; a central portion of the wear pad located between the first leg and the second leg, wherein the wear pad is substantially U-shaped, and wherein the central portion defines the sacrificial surface; an inner surface shaped complementary to the portion of the mounting bracket; an outer surface; and a thickness measured from the inner surface to the outer surface.

In another aspect, an exemplary embodiment of the present disclosure may provide a mounting bracket for a leaf spring suspension system, the mounting bracket: a first end configured to be directly or indirectly coupled to a chassis and a second end opposite the first end, wherein at least one leaf in the leaf spring leaf spring suspension system is configured to be directly or indirectly coupled to the mounting bracket; and a wear pad between the first end and the second end, wherein the wear pad has a sacrificial surface that contacts the at least one leaf and the sacrificial surface wears down in response to friction and abrasion caused by movement of the at least one leaf and protects a portion of the mounting bracket to which the wear pad is mounted. This exemplary embodiment or another exemplary embodiment may further comprise a first end of the wear pad; a second end of the wear pad; wherein the sacrificial surface of the wear pad is located between the first end and the second end of the wear pad. This exemplary embodiment or another exemplary embodiment may further comprise a first leg of the wear pad; a second leg of the wear pad; a central portion of the wear pad located between the first leg and the second leg, wherein the wear pad is substantially U-shaped, wherein the central portion defines at least a portion of the sacrificial surface. This exemplary embodiment or another exemplary embodiment may further comprise an inner surface of the wear pad; an outer surface of the wear pad; a thickness of the wear pad that is measured from the inner surface to the outer surface, wherein the thickness of the wear pad is uniform prior to installation on the mounting bracket. This exemplary embodiment or another exemplary embodiment may further provide that the thickness of the wear pad is reduced at the central portion as the sacrificial surface contacts the at least one leaf. This exemplary embodiment or another exemplary embodiment may further comprise a first aperture defined in the first leg extending transversely through the thickness of the wear pad from the first surface to the second surface of the wear pad. This exemplary embodiment or another exemplary embodiment may further comprise a connector that extends through the first aperture to couple the wear pad to the mounting bracket. This exemplary embodiment or another exemplary embodiment may further comprise a second aperture defined in the second leg extending transversely through the thickness of the wear pad from the first surface to the second surface of the wear pad. This exemplary embodiment or another exemplary embodiment may further comprise a connector that extends through the second aperture to couple the wear pad to the mounting bracket.

In yet another aspect, an exemplary embodiment of the present disclosure may provide a method for a leaf spring suspension system, the method comprising: installing a wear pad at an installation location between a portion of a mounting bracket and a leaf spring in a leaf spring suspension system; moving the leaf spring relative to mounting bracket; contacting the wear pad with at least one of the portion of the mounting bracket and the leaf spring while moving the leaf spring relative to the mounting bracket; wearing down a sacrificial surface on the wear pad as the leaf spring moves relative to the mounting bracket; and protecting at least one at least one of the portion of the mounting bracket and the leaf spring by wearing down the sacrificial surface on the wear pad. This exemplary embodiment or another exemplary embodiment may further comprise inspecting the sacrificial surface of the wear pad; determining whether the sacrificial surface is sufficient for future protection; wherein if it is determined that the sacrificial surface is sufficient for future protection, then maintaining the wear pad installed between the portion of the mounting bracket and leaf spring; and wherein if it determined that the sacrificial surface is insufficient for future protection, then removing the wear pad and installing a second wear pad at the installation location. This exemplary embodiment or another exemplary embodiment may further comprise wherein installing the wear pad at the installation location is accomplished by nesting the wear pad with the portion of the mounting bracket, wherein the wear pad is shaped complementary to the portion of the mounting bracket to which the wear pad is installed. This exemplary embodiment or another exemplary embodiment may further comprise inserting a first connector through a first aperture defined in a first leg of the wear pad; inserting a second connector through a second aperture defined in a second leg of the wear pad; wherein the sacrificial surface is on the wear pad between the first leg and the second leg. This exemplary embodiment or another exemplary embodiment may further comprise reducing the thickness of the wear pad at the sacrificial surface in response to moving the leaf spring in at least two directions relative to the mounting bracket.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a diagrammatic side elevation view of a leaf spring suspension system according to one aspect of the present disclosure.

FIG. 2 is an isometric perspective view of a first mounting bracket having a wear pad according to one aspect of the present disclosure.

FIG. 3 is an exploded perspective view of the first mounting bracket and wear pad.

FIG. 4 is a cross-section view taken along line 4-4 in FIG. 2.

FIG. 5 is an isometric perspective view of a second mounting bracket according to one aspect of the present disclosure.

FIG. 6 is a cross-section view taken along line 6-6 in FIG. 5.

FIG. 7A is an operational cross-section view of a leaf spring coupled with the first mounting bracket and contacting the wear pad.

FIG. 7B is an operational cross-section view depicting the movement of the leaf spring contact the wear pad at a sacrificial surface or a sacrificial portion.

FIG. 7C is a cross-section view depicting the removal of the wear pad after the sacrificed portion has been worn down.

FIG. 7D is a cross-section view depicting the installation of a replacement second wear pad onto the first mounting bracket.

FIG. 7E is a view similar to FIG. 7A but now depicting the replacement second wear pad on the first mounting bracket and coupled with the leaf spring.

FIG. 8 is a cross-section view of another embodiment according to the present disclosure in which a wear pad is disposed on the leaf spring but still between the mounting bracket and a leaf.

Similar numbers refer to similar parts throughout the drawings.

### DETAILED DESCRIPTION

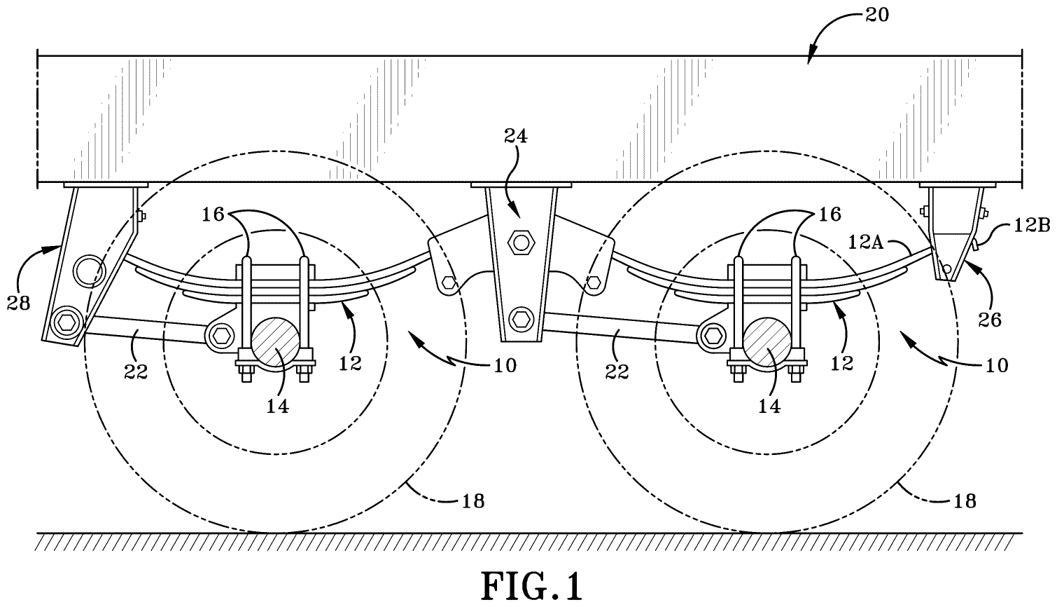

FIG. 1 depicts a leaf spring suspension system or assembly generally at 10. Suspension system 10 includes a leaf spring 12 comprising at least one leaf 12A. The leaf spring 12 may be directly or indirectly coupled to an axle 14 via a U-bolt 16. The suspension system 10 is an intermediary between ground-engaging wheels 18 and the chassis 20 or frame of a vehicle. A torque arm 22 may also be connected, either directly or indirectly to the axle 14. Suspension system 10 may include a central equalizer bracket 24 that acts as a mounting point for one end of the leaf spring 12. The other end of the leaf spring 12 may be connected to a first mounting bracket 26, or simply mounting bracket 26. In one particular embodiment, the first mounting bracket 26 is a rear hanger bracket that is fixedly suspended from the chassis 20. Suspension system 10 may also include another type of mounting bracket, such as the second mounting bracket 28. In one particular embodiment, the second mounting bracket 28 is a forward hanger bracket that is fixedly suspended from the chassis 20. The terms “forward” and “rear” with respect to brackets 26, 28 are used relative to the central equalizer bracket 24 and the ordinary forward drive direction of the vehicle.

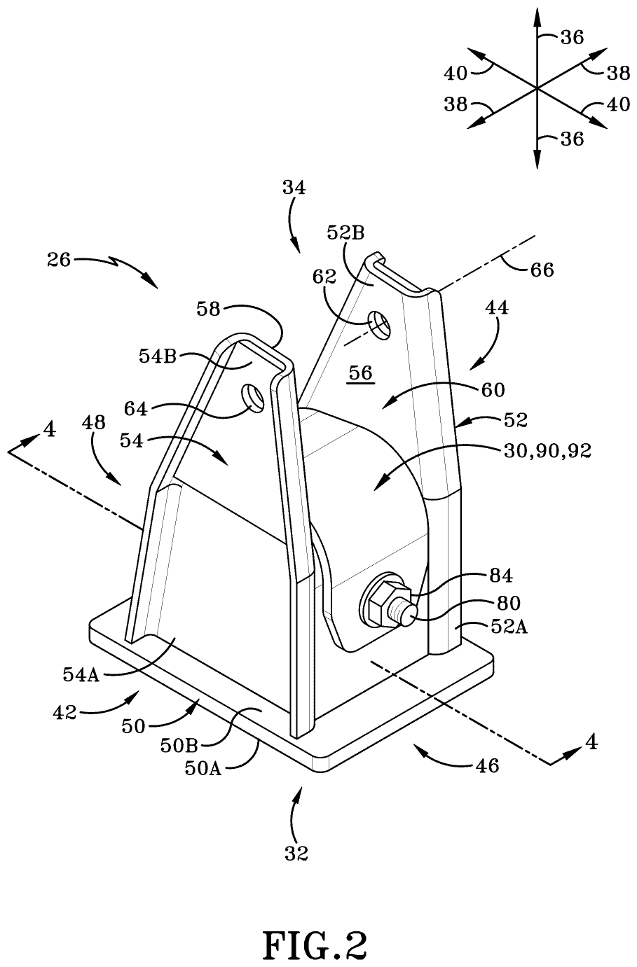

As will be described in greater detail herein, the mounting bracket 26 and the mounting bracket 28 cooperate and interact with each leaf spring 12. More particularly, the leaf spring 12 moves in response to road or ground conditions as the ground-engaging wheel 18 of the vehicle traverses or translates across the ground. The movement of the wheel causes movement of the leaf spring 12. The movement of the leaf spring 12 thereby moves at least one end of the leaf spring 12 relative to either bracket 26 or bracket 28, depending on which bracket 26, 28 the respective leaf spring 12 is coupled. The movement of the leaf spring 12 relative to either bracket 26 or bracket 28 could cause friction and abrasion to either the leaf spring 12 or the respective bracket 26 or 28. Thus, system 10 of the present disclosure provides a wear pad 30 (see FIG. 2).

The wear pad 30 has a sacrificial surface or sacrificial portion that is disposed between the leaf spring 12 in the leaf spring suspension system 10 of the vehicle and a portion of the mounting bracket (either mounting bracket 26 and/or mounting bracket 28) that is coupled with the leaf spring 12. The sacrificial surface of the wear pad 30 is configured to contact the leaf spring 12 and wear down in response to movement of the leaf spring 12. The sacrificial surface is also configured to protect the at least one portion of the mounting bracket, either mounting bracket 26 or mounting bracket 28, from frictional wear and tear. Additionally, the wear pad 30 is configured to be a useable or consumable product that can be removed after it has been worn down and a subsequent or second wear pad, having a similar configuration, can be installed in its place. This should improve the useful life of the other fixed components of the leaf suspension system by reducing wear and tear on the fixed components such as the mounting bracket 26 or 28, or other components like the leaf spring 12.

FIG. 2 depicts the mounting bracket 26 as having a first end 32 and a second end 34 that is opposite the first end 32, defining a first direction 36 therebetween. A second direction 38 and a third direction 40 are orthogonal to the first direction 36. The second direction 38 is defined between a first side 42 and a second side 44 of the mounting bracket 26. The third direction 40 is defined between a third side 46 and a fourth side 48 of the mounting bracket 26. In one particular embodiment, the first direction 36 is generally aligned in a vertical orientation. Further, when the first direction 36 is aligned generally vertical, the first end 32 of mounting bracket 26 is positioned above the second end 34 in order to mount the first end 32 of the mounting bracket 26 to the chassis 20 of the vehicle. Thus, the mounting bracket 26 is shown in an inverted orientation in FIG. 2, however, it is to be understood that operationally the first end 32 will hang down from the chassis 20 of the vehicle such that the mounting bracket 26 may be considered to be a hanger bracket.

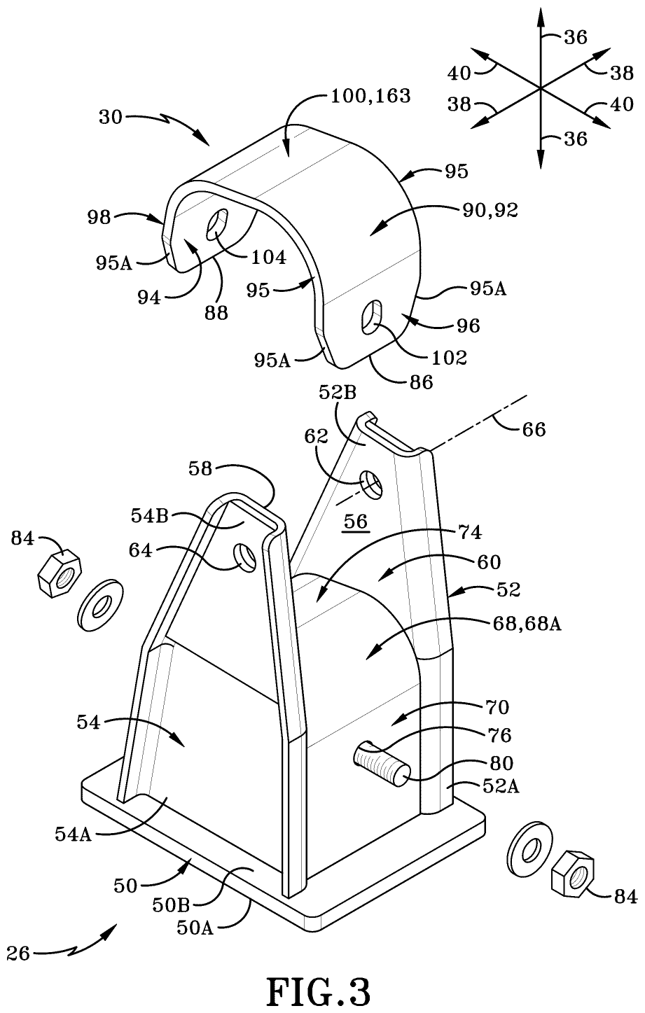

FIG. 2-FIG. 4 depict that the mounting bracket 26 may include a base plate 50 defining the first end 32 of mounting bracket 26. Base plate 50 may have, in one embodiment, a rectangular configuration defining a first surface 50A and a second surface 50B. The first surface 50A may be configured to directly or indirectly connect with chassis 20. Further, while the perimeter edge of base plate 50 is shown as having a rectangular configuration other shapes or configurations of base plate 50 for the mounting bracket 26 are entirely possible.

A first arm 52 extends in the first direction 36 from the base plate 50. A second arm 54 is offset parallel relative to the second direction 38 and is structured as a mirrored opposite of the first arm 52. First arm 52 includes a first end 52A and a second end 52B. Second end 52B defines a portion of the second end 34 of mounting bracket 26. Second arm 54 includes a first end 54A and a second end 54B the inner surface 56 faces the inner surface 58 of the second arm 54. A gap or space 60 is defined between the inner surface 56 of the first arm 52 and the inner surface 58 of the second arm 54. A pair of aligned apertures are defined near the second ends 52B, 54B of the first and second arms 52, 54. More particularly, a first aperture 62 extends through the first arm 52 adjacent its second end 52B. The first aperture 62 extends fully through the first arm 52 parallel to the second direction 38. A second aperture 64 extends fully through the second arm 54 and is aligned parallel to the second direction 38 and coaxial with the first aperture 62 along axis 66.

An interior member 68 on the bracket 26 is located between first arm 52 and second arm 54. In one particular embodiment, the interior member 68 defines a portion of the mounting bracket 26 that is to be protected by wear pad 30. The interior portion 68 includes a first portion 70, a second portion 72, and a third portion 74, that collective define a generally U-shaped configuration. The end 70A of the first portion 70 is connected with the second surface 50B of base plate 50. The end 72A of the second portion 72 is connected with the second surface 50B of base plate 50. Interior member 68 includes an outer surface 68A and an interior surface 68B. A thickness of the interior member 68 is defined between the outer surface 68A and the inner surface 68B. The outer surface 68A may also be considered as a portion of the interior member that is to be protected by the wear pad 30.

An aperture 76 is formed in the first portion 70 of interior member 68. Aperture 76 extends fully through the thickness of the first portion 70 between the inner surface 68B and the outer surface 68A. An aperture 78 is formed in the second portion 72 of the interior member 68 and extends fully through the thickness of the interior member 68 between the inner surface 68B and the outer surface 68A. The apertures 76, 78 are generally aligned in the third direction 40. A first connector 80 extends through aperture 76 and a second connector 82 extends through second aperture 78. In one embodiment, connectors 80, 82 are bolts that may be threaded to receive nuts 84.

With continued reference to FIG. 2-FIG. 4, the wear pad 30 includes a first end 86 and a second end 88. The wear pad 30 includes a body portion 90 that extends between the first end 86 and the second end 88. The “body” or body portion 90 of the wear pad 30 includes an outer surface 92 and an inner surface 94. A thickness of the body portion 90 of the wear pad 30 is defined between the inner surface 94 and the outer surface 92. The body 90 defines a first leg 96, a second leg 98 and a central portion 100 between the first leg 96 and the second leg 98. At the central portion 100, the outer surface 92 of the wear pad 30 is the sacrificial surface. The sacrificial surface is configured to contact the leaf 12A such that the sacrificial surface wears down in response to friction and abrasion caused by movement of the at least one leaf 12A to thereby protect a portion of the mounting bracket 26 to which the wear pad 30 is mounted. More particularly, the sacrificial surface of the wear pad 30 is configured to protect, in one embodiment, the interior member 68, which is the portion of the mounting bracket to which the wear pad 30 is mounted. However, it is to be understood that the wear pad 30 may protect a different portion of the mounting bracket 26 if desired or needed to meet an application specific need.

In one embodiment, the wear pad 30, and more particularly the body portion 90 of the wear pad 30, is shaped complementary to the portion of the mounting bracket 26 to which the wear pad is coupled, mounted, or otherwise attached. When the wear pad 30 is connected to the interior member 68 of the mounting bracket 26, the wear pad 30 has a generally U-shaped configuration as shown in FIG. 2-FIG. 4.

In one exemplary embodiment, the thickness of the wear pad 30, particularly the thickness of the body portion 90 of the wear pad 30, that is defined between the outer surface 92 and the inner surface 94 is uniform between the first end 86 and the second end 88 prior to the wear pads installation on the mounting bracket 26. The thickness of the wear pad is uniform prior to the installation and is configured to be worn down at the sacrificial surface, such as at the central portion 100 as a portion of the leaf spring 12, such as leaf 12A, moves relative to the wear pad 30, as will be described in greater detail herein. The thickness of the body portion 90 of the wear pad 30 can be determined or provided by the manufacturer of the wear pad 30 depending on application specific needs and the amount of time or amount of use required by the wear pad. However, it is entirely possible for the thickness of the wear pad to be non-uniform. For example, the portion of the wear pad 30 that includes to sacrificial surface or the “portion to be sacrificed” can be thicker than other portions of the wear pad.

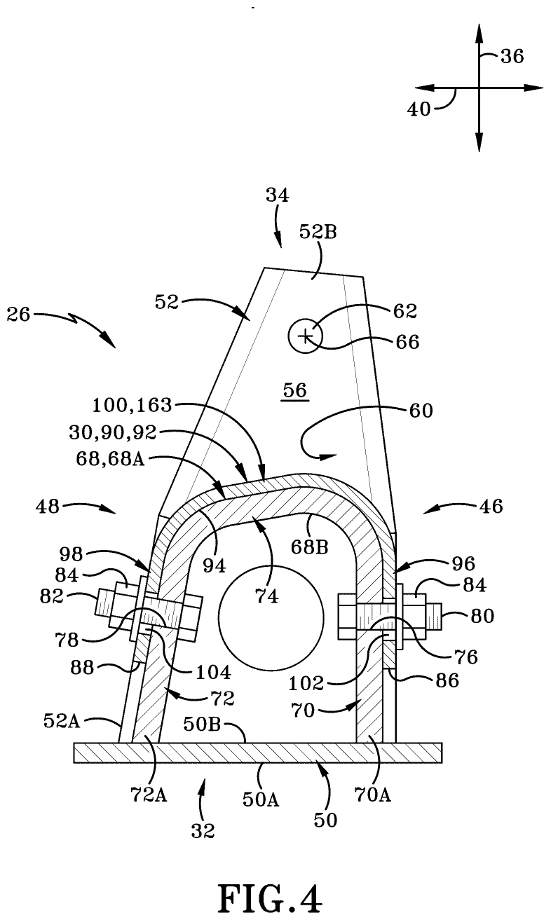

The wear pad 30 includes or defines a first aperture 102 defined in the first leg 96 of the body portion 90. First aperture 102 extends fully through the body of wear pad 30 between the outer surface 96 and the inner surface 94. The through opening defined by aperture 102 is aligned in the third direction 40. The second aperture 104 is defined in the second leg 98 of the body portion 90 of wear pad 30. The second aperture 104 extends fully through the body of wear pad 30 between the inner surface 94 and the outer surface 92. The opening of the aperture 104 is aligned in the third direction 40. When the wear pad 30 is installed on the mounting bracket, the apertures 102, 104 align with aperture 76 and aperture 78 in the interior member 68, respectively, to allow connectors 80, 82 to be inserted through the aligned apertures as shown in FIG. 4. The connectors 80, 82 allow the wear pad 30 to be removably installed on the mounting bracket so as to allow the wear pad 30 to be removed after the sacrificial surface has been worn down, as detailed herein.

When the wear pad 30 is formed as a generally, substantially, or an entirely U-shaped configuration, the wear pad 30 is configured to nest with a portion of the mounting bracket 26. More particularly, the wear pad 30 nests with the interior member 68. When the wear pad 30 is nested with or nested on the interior member 68, the inner surface 94 of the first leg 96 directly contacts or is otherwise closely adjacent the outer surface 68A of the first portion 70 of the interior member 68. Further, when the wear pad 30 is nested with or on the interior member 68, the inner surface 94 of the second leg 98 directly contacts or is closely adjacent the outer surface 68A at the second portion 72 of interior member 68. Still further, when the wear pad 30 is nested with or on the interior member 68, the inner surface 94 of the central portion 100 directly contacts or is closely adjacent the outer surface 68A of the third portion 74 of the interior member 68.

Although the embodiments shown in FIG. 2-FIG. 4 depict the wear pad 30 being connected to the mounting bracket 26 via bolts 80, 82, it is entirely possible to use a different kind of connector. For example, a pressure sensitive adhesive could be applied between the inner surface 94 of the wear pad and the outer surface 68A of the interior member 68. The pressure sensitive adhesive could be utilized to establish the releasable connection of the wear pad 30 relative to the interior member 68 in the space 60 between the first arm 52 and second arm 54 of the mounting bracket 26. Still further, other types of mechanical connectors can be utilized in lieu of the bolts 80, 82. Still further, other types of mechanisms or manners that are non-mechanical and non-chemical could be utilized to connect the wear pad 30 to the mounting bracket 26 in a removable manner that would permit the installation removal of the wear pad 30 once the sacrificial surface of the wear pad 30 had been sufficiently worn down so as to justify the replacement of the wear pad 30 with an identical but subsequent (i.e. new) wear pad.

The wear pad 30 includes a minor sidewall 95 that is defined by the thickness of the body portion 90 between the outer surface 92 and the inner surface 94. The sidewall 95 extends continuously around the perimeter of the body portion 90 of wear pad 30. In one particular embodiment, sidewall 95 is uninterrupted around the entire perimeter of the body portion 90 of wear pad 30. Although the sidewall 95 is continuous and uninterrupted, it may include angled portions or tapered sections 95A adjacent the first end 86 the second end 88 of the body portion 90. The tapered sections 95A narrow the width, but not the thickness, of the body portion 90 adjacent the first and second ends 86, 88, respectively. The tapered sections 95A may assist with the installation, and more particularly the insertion of the wear pad 30 onto the interior member 68 of the mounting bracket. In one particular embodiment, the tapered sections 95A begin to taper towards the first end 86 and the second end 88 at a plane that intersects aperture 102 and aperture 104.

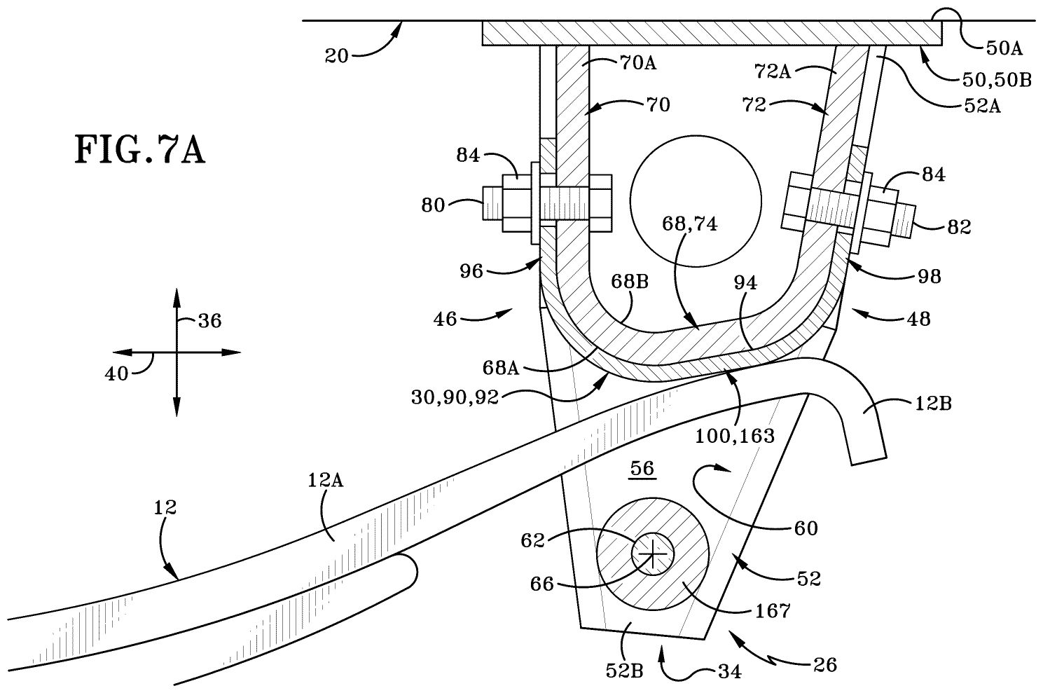

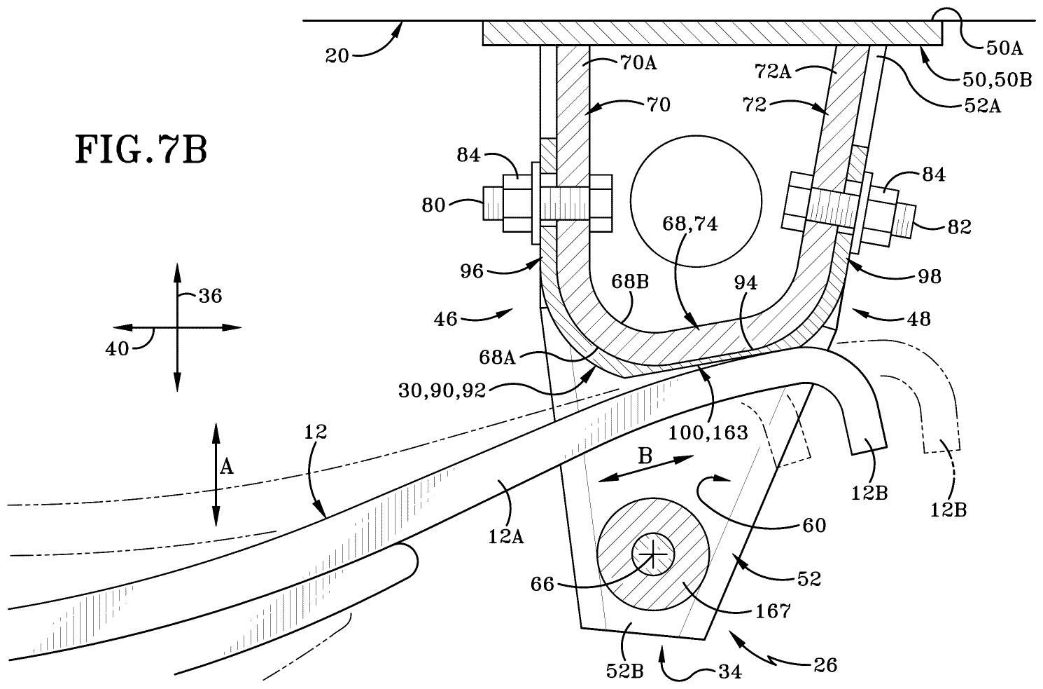

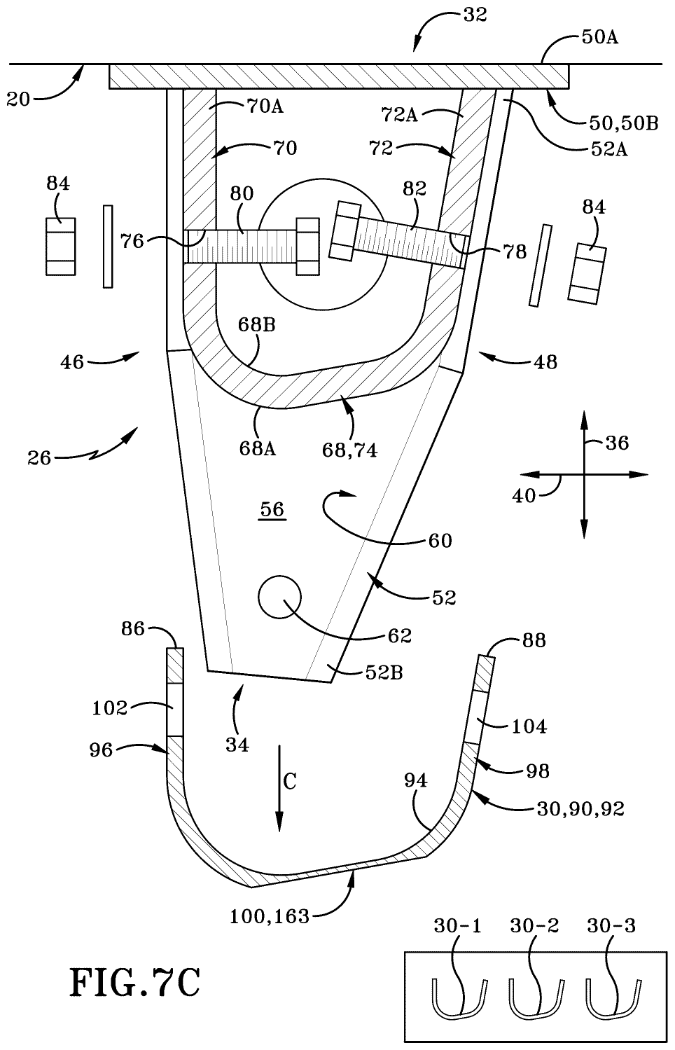

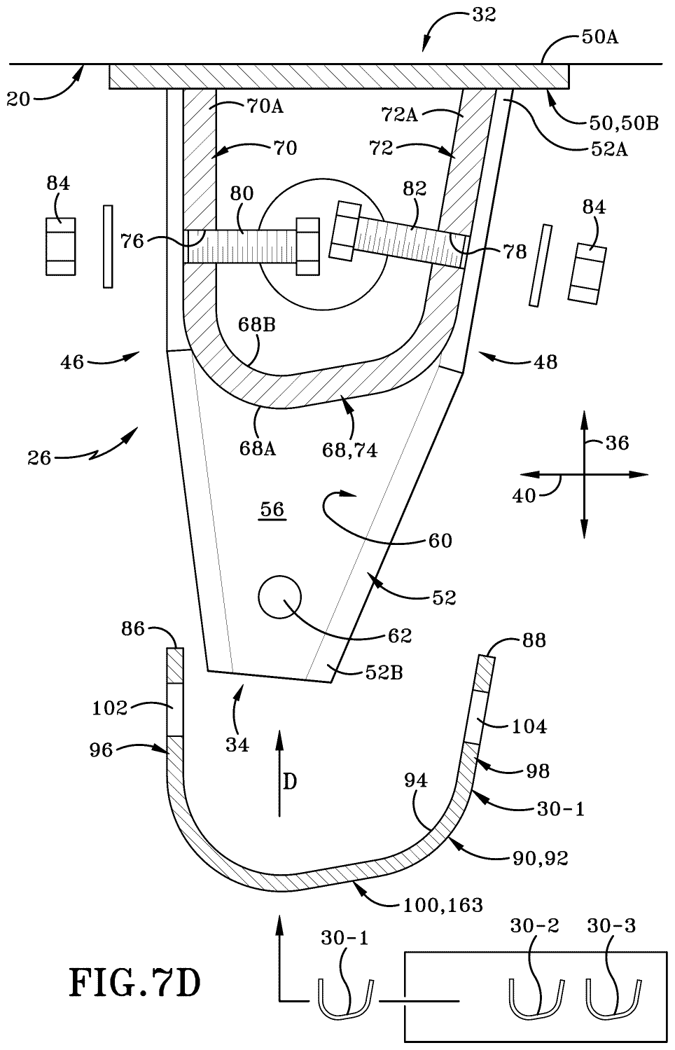

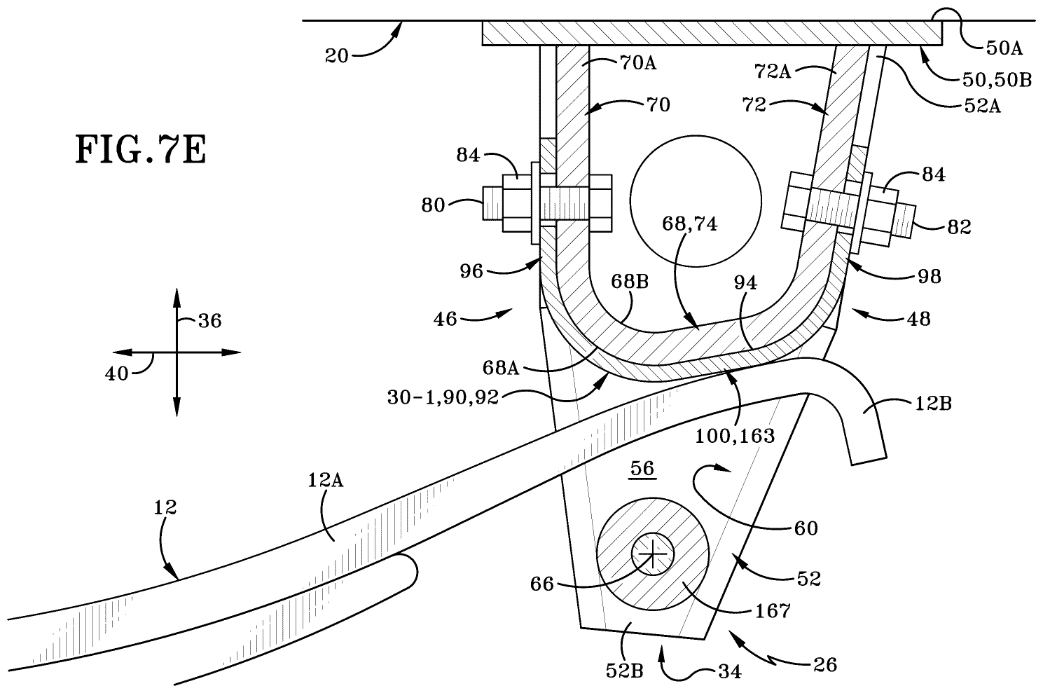

The outer surface 92 of the body portion 90 of the wear pad 30 may be continuous and uninterrupted except for the interruptions created by apertures 102, 104. In one particular embodiment, the outer surface 92 is relatively smooth to provide abrasion and friction reduction properties for when a sacrificed portion 163 (see FIG. 7B) or sacrificial surface at central portion 100 is contacted by leaf 12A in the leaf spring 12, however, it may be possible that other embodiments of the present disclosure provide a slightly roughened or textures outer surface 92 should it be desired to meet an application specific need or purpose.

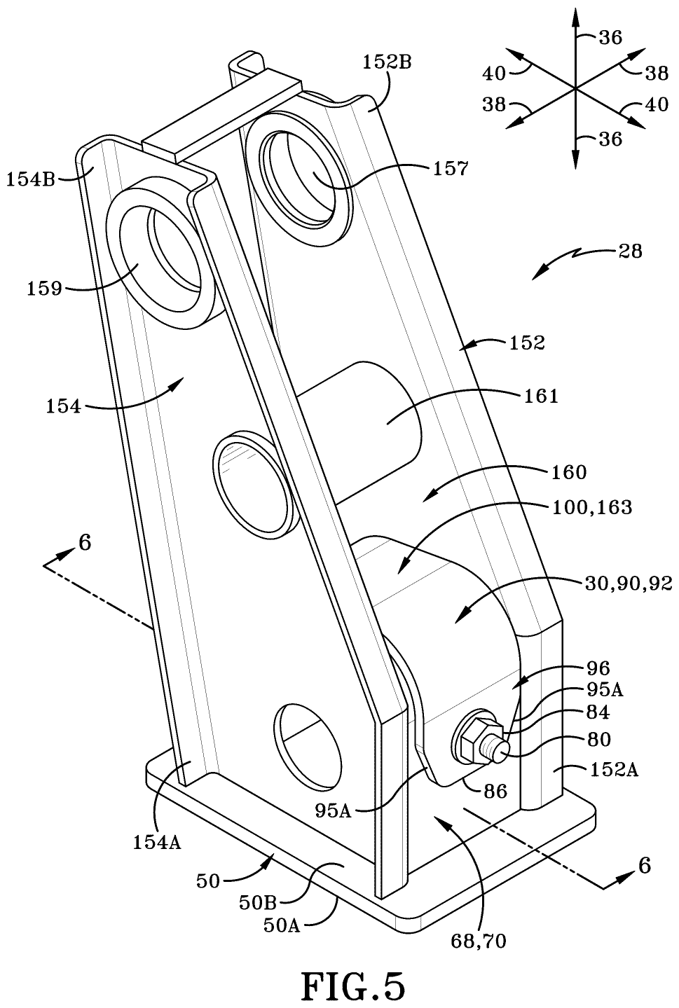

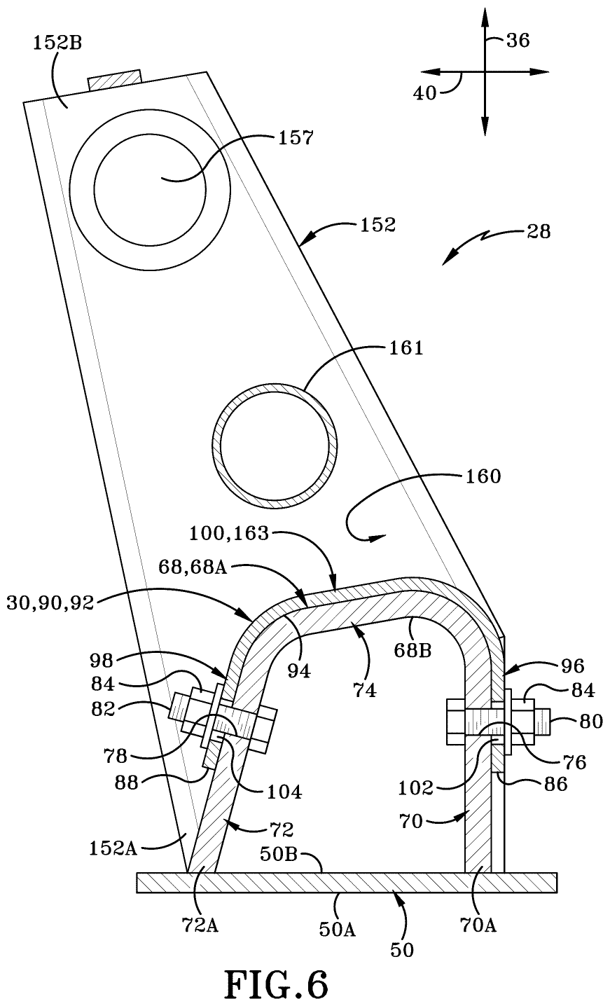

FIG. 5-FIG. 6 depict the interaction of the wear pad 30 with the second mounting bracket 28. The second mounting bracket 28 has many similar components as the first mounting bracket 26 and parts labeled with similar numbers are not repeated for brevity. Most particularly, the wear pad 30 interacts with the intermediate member 68 on the second mounting bracket 28 in a manner similar as previously described with respect to the first mounting bracket 26. Second mounting bracket 28 differs from the first mounting bracket 26 in that the first arm 152 and the second arm 154 have a greater length measured in the first direction 36 than the arms 52, 54 of the first mounting bracket 26. First arm 152 extends between the first end 152A and the second end 152B and the second arm 154 extends between a first end 154A and a second end 154B. The distance between ends 152A and 152B and the distance ends 154A and 154B is greater than that of first bracket 26.

Bracket 28 includes a pair of bosses, wherein one boss is on each respective arm 152, 154 adjacent their second ends 152B, 154B, respectively. The bosses surround aperture 157 and aperture 159. Each boss surrounding the apertures 157, 159 is utilized to connect with the torque arm 22 as shown in FIG. 1. Between the wear pad 30 and the apertures 157, 159 in the gap 160 defined between the first arm 152 and the second arm 154 is a bar 161. The bar 161 is configured to interact with a portion of the leaf spring 12 in order to retain the end of the leaf spring between the bar 161 and the outer surface 92 of wear pad 30, wherein a portion of the outer surface 92 defines the sacrificial surface.

Having thus described the general configuration of system 10, reference will now be made to its operation and the usage of wear pad 30, having the sacrificial surface, such as the outer surface 92 at the central portion 90, that is disposed between the leaf 12A of leaf spring 12 and the mounting bracket, such as mounting bracket 26 or mounting bracket 28.

FIG. 7A-FIG. 7E are discussed with reference to mounting bracket 26, however the operational embodiments equally apply to second mounting bracket 28 but are not repeated for brevity. A manufacturer or a user can install the wear pad 30 at an installation location between a portion of the mounting bracket 26 and a leaf 12A on the leaf spring in a leaf spring suspension system. In this embodiment, the installation location is the location within the gap 60 (or gap 160) on the outer surface 68A of the intermediate member 68. However, it is to be understood that the installation location can be another location on the mounting bracket if necessary to meet an application specific need. The installation will occur by aligning the wear pad 30, and more particularly its ends 86, 88, generally upward. The installation will continue such that the pad is moved upward in the first direction 36. The wear pad 30 continues to move upward in the first direction 36 until the inner surface 94 of the wear pad 30 nests with the outer surface 68A of the interior member 68. When nested, the aperture 102 will align with aperture 76 and the aperture 104 will align with aperture 78. Thereafter, a connector, such as bolt 80, may be utilized to connect the wear pad 30 to the mounting bracket 26 at the installation location. Further, as described previously herein, the use of bolts 80 and nuts 84 is not necessary in every embodiment to connect the wear pad 30 to the mounting bracket 26. Other manners or members can be utilized to connect the wear pad 30 with the mounting bracket 26.

With the wear pad 30 installed on the mounting bracket 26, the leaf spring 12 may be moved. FIG. 7B depicts the movement of the leaf spring 12. Ordinarily, the movement of leaf spring occurs in response to movement of the vehicle as the ground-engaging wheels 18 traverse over a road or other surface. The movement of the leaf spring 12 is indicated by arrow A and arrow B. Arrow A represents the vertical deflection of the leaf spring 12 in the first direction 36 and arrow B represents the translation movement of the leaf spring in the third direction 40. Phantom lines on the leaf 12A of leaf spring 12 further depict the vertical movement in the direction of arrow A and the translation of leaf 12 in the third direction 40. As the leaf spring 12 is moved relative to the mounting bracket 26 the surface of leaf 12A contacts the wear pad 30. More particularly, the leaf 12A of leaf spring 12 moves relative to the stationary wear pad 30.

As seen in FIG. 7B, a sacrificed portion 163 is shown as having been worn down as a result of the movement in the direction of arrow A and arrow B of leaf 12A of leaf spring 12. The sacrificed portion 163 results in the wear pad 30 having a narrower width at the sacrificed portion 163. By utilizing the wear pad 30, and more particularly sacrificing the sacrificed portion 163 in response to movement of leaf spring 12, the wear pad 30 is able to protect the portion of the mounting bracket 26 to which the wear pad 30 is installed by wearing down the sacrificial surface on the wear pad 30 rather than another portion of the mounting bracket 26. In this example, when the wear pad 30 is attached to the interior member 68, the wear pad 30 sacrifices the sacrificed portion 163 instead of the leave spring 12 damaging the interior member 68.

Also shown in FIG. 7B, but not in other Figures, is another bar 167 aligned along axis 66 that is used to retain the end 12B of leaf 12A in operative connection with the mounting bracket 26. The end 12B of leaf 12A is bent in a manner so as to prevent the leaf 12A from moving out of its operational engagement with mounting bracket 26. Thus, the bar 167 can be considered as a retention bar that effectuates the operative connection of the end 12B of leaf 12A to the mounting bracket 26.

FIG. 7C and FIG. 7D depict the replacement of the damaged wear pad 30 with a second or replacement wear pad that is identical to the first wear pad that was sacrificed. A user or another sensor will inspect the sacrificed surface 163 on the wear pad 30. Then, a determination is made to determine whether the sacrificed portion 163 or the sacrificial surface is sufficient for future protection of some portion of the mounting bracket 26. If it is determined that the sacrificial surface or the sacrificed portion 163 is still sufficient for future protection of the mounting bracket, then the wear pad 30 may be maintained in its installed position at the installation position between the portion of the mounting bracket that is to be protected and the leaf 12A of leaf spring 12. If however, it is determined that the sacrificial portion 163 is insufficient for future protection of the portion of the mounting bracket 26, then the system 10 is subjected to a corrective action or a corrective measure. One exemplary corrective action provided by the system 10 of the present disclosure is removing the wear pad 30 and installing a replacement second wear pad at the installation location. Particularly, FIG. 7C depicts the removal of the damaged wear pad 30. The removal of the damaged wear pad 30 may be accomplished by disconnecting the connectors that connected the wear pad to the mounting bracket 26. In this particular embodiment, this would be accomplished by loosening the bolts 80 and nuts 84. Then, once the bolts 80 and nuts 84 are loosened, the wear pad 30 may be removed as indicated by arrow C. However, it bolts were not used, the removal could be accomplished in a different manner.

As depicted in FIG. 7C and FIG. 7D, a kit or supply of replacement wear pads, such as replacement wear pad 30-1, 30-2, or 30-3 may be supplied to the owner of the vehicle. This kit could be carried by the vehicle or could be located remote from the vehicle and stored in a repair facility. After the damaged wear pad 30 is removed and discarded, one of the replacement wear pads, such as replacement wear pad 30-1, may be reinstalled onto the mounting bracket 26 as indicated by arrow D. The replacement wear pad 30-1 is identical to the original wear pad prior to its surface having been sacrificed. The process of removing the damaged wear pad 30 may be reversed so as to install the replacement wear pad 30-1 in a manner similar to that in which the original wear pad 30 was installed. Namely, nesting the interior surface of the replacement wear pad 30-1 with the interior member 68 and connecting the replacement wear pad 30-1 via bolt 80 and nut 84 (or connecting in another manner, if applicable).

FIG. 7E depicts the installation of the replacement wear pad 30-1 after the original damaged wear pad 30 was sacrificed. This process may continue to ensure longevity and protection of the mounting bracket 26 by sacrificing the wear pad instead of damaging portions of the mounting bracket.

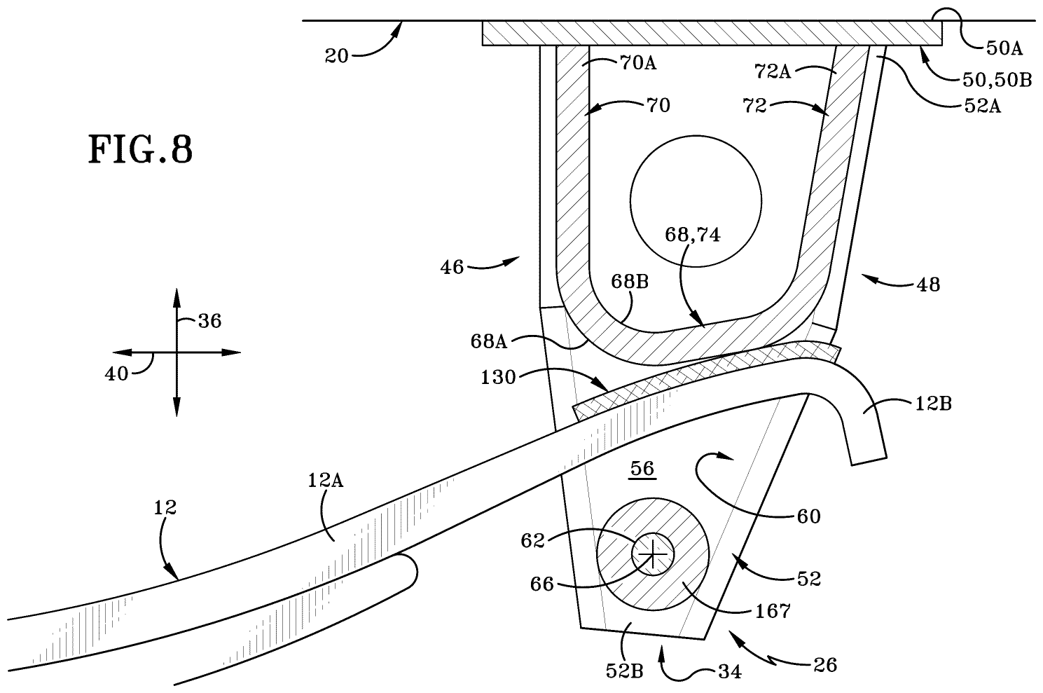

Although the previous embodiment has been shown with the wear pad 30 installed at the installation location on a portion of the mounting bracket, it is to be understood that the wear pad can be installed at other installation locations in the leaf spring suspension system 10 so long as the wear pad is located between leaf spring 12 and a portion of the mounting bracket. For example, FIG. 8 depicts an embodiment in which the installation location of another embodiment of a wear pad, shown as wear pad 130, is on the upper surface of the leaf 12A of leaf spring 12. This exemplary wear pad 130 may have a configuration that is shaped complementary to the leaf spring. In this embodiment, the wear pad 130 could have a generally rectangular configuration having a length that is shorter than the length of the leaf spring and a width that is similar to that of the leaf 12A or leaf spring 12. Notably, the width of the wear pad could be the same as the width of the leaf spring or less than the width of the leaf spring. Although the width of this wear pad could be wider than the leaf spring, it may be less desirable to have this greater width, albeit possible. Wear pad 130 could be adhered or otherwise connected to the top surface of the leaf 12A of leaf spring 12 in a manner that can be removed after a portion of the wear pad 130 is sacrificed.

The wear pad 30 or 130 described herein may be manufactured from an abrasion resistant material. In one particular embodiment, the wear pad is fabricated from AR450 steel that is a type of abrasion-resistant steel that is designed to withstand wear and abrasion. The “AR” stands for “abrasion resistant,” and the number “450” refers to the Brinell hardness number, which is a measure of the material's hardness and resistance to indentation. In this case, AR450 steel has a hardness of around 450 Brinell, indicating its high level of hardness and durability. However, other embodiments may provide a material that has a hardness that ranges from about 420 to about 480 Brinell. In one optional embodiment, there may be criticality to this range to account for the substantial load exerted on the wear pad 30 or 130 by leaf spring 12. Other materials having a different hardness on the Brinell range may be utilized if desirable to meet an application specific need of the system 10. The high hardness of AR450 steel comes from its composition and heat treatment, which typically involve alloying elements. These elements contribute to the steel's ability to form a hardened surface layer that resists wear and deformation. AR450 steel is a form of high-strength low-alloy (HSLA) steel that is alloyed with various elements to enhance its mechanical and wear-resistant properties. Although AR450 is described herein, other HSLA steel may be utilized to form or fabricate the wear pad. For example, the wear pad 30 or 130 may also be fabricated from Hardox® (Hardox® is a registered trademark of SSAB TECHNOLOGY AB CORPORATION of Stockholm, Sweeden), which is another type of abrasion-resistant hardened steel.

The typical chemical composition of AR450 steel can vary slightly depending on the manufacturer and specific production process, but generally, it includes the following elements: Carbon (C), Manganese (Mn), Phosphorus (P) and Sulfur (S), Chromium (Cr), Nickel (Ni) and other trace elements that form the alloy. Carbon is the primary element that contributes to the steel's hardness and strength. AR450 steel typically contains higher carbon content compared to standard structural steels, which contributes to its increased hardness. Manganese is added to enhance the steel's toughness and hardenability. It also contributes to the steel's ability to form a hardened surface layer. Phosphorus and Sulfur are generally kept at lower levels in AR450 steel to improve its ductility and toughness. Chromium is sometimes added to improve the steel's corrosion resistance and wear resistance. Nickel and other trace elements might be present in small amounts to further refine the steel's properties.

AR450 steel may also be suitable for wear pad 30 or 130 inasmuch as it has good tensile strength and yield strength, which means it can withstand high levels of mechanical stress and loading. While AR450 steel is primarily designed for wear resistance, it also possesses a certain level of toughness that allows it to absorb some amount of impact without fracturing. This balance between hardness and toughness is important for its performance in this suspension system 10. AR450 steel can be welded using appropriate welding techniques and procedures. However, the high hardness and abrasion resistance of AR450 can make welding more challenging than with regular mild steels. Special precautions, such as preheating and controlled cooling, may be necessary to avoid potential cracking during welding. The forming processes, like bending and rolling of AR450 steel, may require more force and specialized equipment.

One exemplary advantage of wear pad 30 or 130 lies in its ability to considerably extend the service life of both the hanger or mounting bracket and the leaf spring. By diverting the wear to the sacrificial surface of the wear pad 30 or 130, the abrasive effects on the hanger or mounting bracket can be reduced, ensuring that it remains functional and durable over an extended period. Implementing a sacrificial surface wear pad enables system 10 to address wear-related concerns in a more efficient manner. Instead of replacing entire suspension components or engaging in costly repairs, system 10 can simply replace the wear pad 30 or 130, which is a more straightforward and economical process. This results in reduced downtime and maintenance costs. As the wear pad 30 or 130 gradually erodes, the contact characteristics between the leaf spring 12 and the hanger or mounting bracket remain relatively stable. This should help maintain consistent suspension performance and ensures that the vehicle's ride quality and handling characteristics are not compromised due to changing frictional conditions. By having the wear pad 30 or 130 as an intermediary between the leaf spring 12 and the hanger or mounting bracket, system 10 gains the freedom to select materials for the wear pad 30 or 130 that are optimized for abrasion resistance. This decoupling of material choice can lead to more efficient designs, tailored for specific performance objectives.

The system 10 of the present disclosure may additionally include one or more sensors to sense or gather data pertaining to the surrounding environment or operation (i.e., wear status/state of the sacrificial surface) of the wear pad 30 or 130. Some exemplary sensors capable of being electronically coupled with the wear pad 30 or 130 of the present disclosure (either directly connected to the wear pad 30 or 130 or system 10 of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; Global Positioning sensors sensing location, elevation, distance traveled, velocity/speed; audio sensors sensing local environmental sound levels, or voice detection; Photo/Light sensors sensing the wear pad surface; Temperature sensors sensing wear pad temperature; calipers or other electronic measuring devices do determine the thickness and amount of wear of the wear pad 30 or 130; and Moisture Sensors sensing surrounding moisture levels on the wear pad.

If sensors are utilized to gather data relating to the wear pad 30 or 130, or system 10, then sensed data may be evaluated and processed with artificial intelligence (AI). For example, AI may be utilized to make a determination that the wear pad 30 or 130 needs to be replaced after the sacrificial surface has been worn down to a point that the wear pad 30 or 130 need to be replaced with a new wear pad. Analyzing data gathered from sensors using artificial intelligence involves the process of extracting meaningful insights and patterns from raw sensor data to produce refined and actionable results. Raw data is gathered from various sensors, for example those which have been identified herein or others, capturing relevant information based on the intended analysis. This data is then preprocessed to clean, organize, and structure it for effective analysis. Features that represent key characteristics or attributes of the data are extracted. These features serve as inputs for AI algorithms, encapsulating relevant information essential for the analysis. A suitable AI model, such as machine learning or deep learning (regardless of whether it is supervised or unsupervised), is chosen based on the nature of the data and the desired analysis outcome. The model is then trained using labeled or unlabeled data to learn the underlying patterns and relationships. The model is fine-tuned and optimized to enhance its performance and accuracy. This process involves adjusting parameters, architectures, and algorithms to achieve better results. The trained model is used to make predictions or inferences on new, unseen data. The model processes the extracted features and generates refined output based on the patterns it has learned during training. The results produced by the AI model are refined through post-processing techniques to ensure accuracy and relevance. These refined results are then interpreted to extract meaningful insights and derive actionable conclusions. Feedback from the refined results is used to improve the AI model iteratively. The process involves incorporating new data, adjusting the model, and enhancing the analysis based on real-world feedback and evolving requirements. Further, AI results can be used to alter the operation of the device, assembly, or system of the present disclosure based on feedback. For example, AI feedback can be used to improve the efficiency of the device, assembly, or system of the present disclosure by responding to predicted changes in the environment or predicted changes to the device, assembly, or system of the present disclosure more quickly than if only sensed by one or more of the sensors.

A sensor model may be employed, once trained, in the system 10 of the present disclosure. In one embodiment, the system 10 of the present disclosure can be used to teach a sensor model to predict sensor data for a specific scenario. For example, the AI may make predictions as to the remaining “useful life” of the wear pad 30 or 130 based on the movements experienced by the vehicle as sensed by the sensors. In another example, the determination of whether the sacrificed surface on the wear pad 30 or 130 is no longer able to adequately protect the suspension assembly may be made by the AI, rather than human visual or human measured inspection.

The AI model and/or sensor model can include a deep neural network (DNN), convolutional neural network (CNN), another neural network (NN) or the like and can support generative learning. For example, the sensor model can include a generative adversarial network (GAN), a variational autoencoder (VAE), and/or another type of DNN, CNN, NN or machine learning model (e.g., natural language processing (NLP)). Generally, the sensor model can accept some encoded representation of a vehicle or suspension movements as input using any number of data structures and/or channels (e.g., concatenated vectors, matrices, tensors, images, etc.).

The system 10 of the present disclosure, or the vehicle on which system 10 is mounted, may include wireless communication logic coupled to sensors on the wear pad 30 or 130. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wi-Fi®, ZigBee®, MIWI, BLUETOOTH®) for communication. In one example, each of the devices, assemblies, or systems of the present disclosure may have its own IP address and may communicate directly with a router or gateway. This would typically be the case if the communication protocol is Wi-Fi®. (Wi-Fi® is a registered trademark of Wi-Fi Alliance of Austin, TX, USA; ZigBee® is a registered trademark of ZigBee Alliance of Davis, CA, USA; and BLUETOOTH® is a registered trademark of Bluetooth Sig, Inc. of Kirkland, WA, USA).

In another example, a point-to-point communication protocol like MiWi or ZigBee® is used. One or more of the device, assembly, or system of the present disclosure may serve as a repeater, or the devices, assemblies, or systems of the present disclosure may be connected together in a mesh network to relay signals from one device, assembly, or system to the next. However, the individual device, assembly, or system in this scheme typically would not have IP addresses of their own. Instead, one or more of the devices, assemblies, or system of the present disclosure communicates with a repeater that does have an IP address, or another type of address, identifier, or credential needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system that receives and processes signals from the device, assembly, or system of the present disclosure may differ from embodiment to embodiment. In one embodiment, alerts and signals from the device, assembly, or system of the present disclosure are sent through an e-mail or simple message service (SMS; text message) gateway so that they can be sent as e-mails or SMS text messages to a remote device, such as a smartphone, laptop, or tablet computer, monitored by a responsible individual, group of individuals, or department, such as a maintenance department. Thus, if a particular device, assembly, or system of the present disclosure creates an alert because of a data point gathered by one or more sensors, such as an alert or determination that the wear pad 30 or 130 has been worn down to a point where it needs replaced, that alert can be sent, in e-mail or SMS form, directly to the individual responsible for fixing it. Of course, e-mail and SMS are only two examples of communication methods that may be used; in other embodiments, different forms of communication may be used.

In other embodiments, alerts and other data from the sensors on the device, assembly, or system of the present disclosure may also be sent to a work tracking system that allows the individual, or the organization for which he or she works, to track the status of the various alerts that are received, to schedule particular workers to repair or replace a particular wear pad 30 or 130, and to track the status of those repair jobs. A work tracking system would typically be a server, such as a Web server, which provides an interface individuals and organizations can use, typically through the communication network. In addition to its work tracking functions, the work tracker may allow broader data logging and analysis functions. For example, operational data may be calculated from the data collected by the sensors on the device, assembly, or system of the present disclosure, and the system may be able to provide aggregate machine operational data for a device, assembly, or system of the present disclosure or group of devices, assemblies, or systems of the present disclosure.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, instead of the wear pad 30 being generally or substantially U-shaped, the wear pad 30 can be semi-circular, circular, triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any other letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, V-shaped, W-shaped, X-shaped, Y-shaped, or Z-shaped), or any other type of regular or irregular, symmetrical or asymmetrical configuration.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element, or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or indirectly connecting in which intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A wear pad comprising:
a sacrificial surface that is disposed between a leaf spring in a leaf spring suspension system of a vehicle and a portion of a mounting bracket coupled to the leaf spring;
wherein the sacrificial surface is configured to protect at least one of (a) the portion of the mounting bracket and (b) the leaf spring from frictional wear-and-tear; and
wherein the sacrificial surface contacts the leaf spring and wears down in response to movement of the leaf spring.

2. The wear pad of claim 1, wherein the wear pad is shaped complementary to at least one of (a) the portion of the mounting bracket and (b) the leaf spring.

3. The wear pad of claim 2, wherein the wear pad is a U-shaped configuration.

4. The wear pad of claim 1, further comprising a feature to promote removal of the wear pad after the sacrificial surface is worn down and subsequent installation of a second wear pad.

5. The wear pad of claim 4, wherein the feature to promote the removal of the wear pad is a releasable connector.

6. The wear pad of claim 1, further comprising:
a first leg;
a second leg;
a central portion of the wear pad located between the first leg and the second leg, wherein the wear pad is substantially U-shaped, and wherein the central portion defines the sacrificial surface;
an inner surface shaped complementary to the portion of the mounting bracket;
an outer surface; and
a thickness measured from the inner surface to the outer surface.

7. A mounting bracket for a leaf spring suspension system, the mounting bracket comprising:
a first end configured to be directly or indirectly coupled to a chassis and a second end opposite the first end, wherein at least one leaf in the leaf spring suspension system is configured to be directly or indirectly coupled to the mounting bracket; and
a wear pad between the first end and the second end, wherein the wear pad has a sacrificial surface that contacts the at least one leaf and the sacrificial surface wears down in response to friction and abrasion caused by movement of the at least one leaf and the wear pad protects a portion of the mounting bracket to which the wear pad is mounted.

8. The mounting bracket of claim 7, further comprising:
a first end of the wear pad;
a second end of the wear pad;
wherein the sacrificial surface of the wear pad is located between the first end and the second end of the wear pad.

9. The mounting bracket of claim 7, further comprising:
a first leg of the wear pad;
a second leg of the wear pad;
a central portion of the wear pad located between the first leg and the second leg, wherein the wear pad is substantially U-shaped, wherein the central portion defines at least a portion of the sacrificial surface.

10. The mounting bracket of claim 9, further comprising;
an inner surface of the wear pad;
an outer surface of the wear pad;
a thickness of the wear pad that is measured from the inner surface to the outer surface, wherein the thickness of the wear pad is uniform prior to installation on the mounting bracket.

11. The mounting bracket of claim 10, wherein the thickness of the wear pad is reduced at the central portion over time in response to the sacrificial surface contacting the at least one leaf.

12. The mounting bracket of claim 10, further comprising:
a first aperture defined in the first leg extending transversely through the thickness of the wear pad from the first surface to the second surface of the wear pad.

13. The mounting bracket of claim 12, further comprising:
a connector that extends through the first aperture to couple the wear pad to the mounting bracket.

14. The mounting bracket of claim 12, further comprising:
a second aperture defined in the second leg extending transversely through the thickness of the wear pad from the first surface to the second surface of the wear pad.

15. The mounting bracket of claim 14, further comprising:
a connector that extends through the second aperture to couple the wear pad to the mounting bracket.

16. A method for a leaf spring suspension system, the method comprising:
installing a wear pad at an installation location between a portion of a mounting bracket and a leaf spring in a leaf spring suspension system;
moving the leaf spring relative to mounting bracket;
contacting the wear pad with at least one of the portion of the mounting bracket and the leaf spring while moving the leaf spring relative to the mounting bracket;
wearing down a sacrificial surface on the wear pad as the leaf spring moves relative to the mounting bracket; and
protecting at least one at least one of the portion of the mounting bracket and the leaf spring by wearing down the sacrificial surface on the wear pad.

17. The method of claim 16, further comprising:
inspecting the sacrificial surface of the wear pad;
determining whether the sacrificial surface is sufficient for future protection;
wherein if it is determined that the sacrificial surface is sufficient for future protection, then maintaining the wear pad installed between the portion of the mounting bracket and leaf spring; and
wherein if it determined that the sacrificial surface is insufficient for future protection, then removing the wear pad and installing a second wear pad at the installation location.

18. The method of claim 16, wherein installing the wear pad at the installation location is accomplished by nesting the wear pad with the portion of the mounting bracket, wherein the wear pad is shaped complementary to the portion of the mounting bracket to which the wear pad is installed.

19. The method of claim 16, further comprising:
inserting a first connector through a first aperture defined in a first leg of the wear pad;
inserting a second connector through a second aperture defined in a second leg of the wear pad;
wherein the sacrificial surface is on the wear pad between the first leg and the second leg.

20. The method of claim 16, wherein wearing down the sacrificial surface further comprises:
reducing the thickness of the wear pad at the sacrificial surface in response to moving the leaf spring in at least two directions relative to the mounting bracket.
